(19) United States
(12) Patent Application Publication
(10) Pub. No.: US 2006/0044495 A1
(43) Pub. Date: Mar. 2, 2006

(54) Transmissive color liquid crystal display device

(75) Inventor: Hisao Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/203,961

(22) Filed: Aug. 16, 2005

(30) Foreign Application Priority Data
Aug. 26, 2004 (JP) P.2004-246269
Aug. 26, 2004 (JP) P.2004-246270

(51) Int. Cl. G02F 1/1335

(52) U.S. Cl. 349/114

(57) ABSTRACT

A transmissive color liquid crystal display device includes a liquid crystal layer arranged a lower polarizing plate on a light source side and an upper polarizing plate on a display side, the liquid crystal layer changing a polarization plane of linearly polarized light having passed through the lower polarizing plate to adjust light transmittance, a color filter arranged between the liquid crystal layer and the upper polarizing plate, a 1/4 phase plate arranged between the upper polarizing plate and the color filter for rotating a polarization plane of external light passing through the upper polarizing plate and reflecting at the color filter to 90° permitting the upper polarizing plate to absorb the external light, and another 1/4 phase plate arranged beneath the color filter. Further, another transmissive color liquid crystal display device includes a liquid crystal layer arranged a lower polarizing plate on a light source side and an upper polarizing plate on a display side, the liquid crystal panel changing a polarization plane of linearly polarized light having passed through the lower polarizing plate to adjust light transmittance, a color filter arranged between the liquid crystal panel and the upper polarizing plate, and an ND filter arranged between the upper polarizing plate and the color filter.

This application is based on Japanese Patent applications JP 2004-246269 and JP 2004-246270, both filed Aug. 26, 2004, the entire contents of which are hereby incorporated by reference. This claim for priority benefit is being filed concurrently with the filing of this application.

### BACKGROUND OF THE INVENTION

1. Technical Field of the Invention

This invention relates to a transmissive color display liquid crystal display device capable of reducing reflection of external light to increase the contrast of a displayed image.

2. Description of the Related Art

At present, as a display for various apparatus, transmissive color liquid crystal display devices are being widely employed. Among them, the liquid crystal display device in a TN (Twisted Nematic) mode which is generally widely used has a structure in which a liquid crystal layer is formed of liquid crystal molecules sealed in a twisted state by 90° between two glass substrates having transparent electrodes and two polarizing plates are arranged orthogonally outside the glass substrates with respect to the liquid crystal layer. Image display of this kind of liquid crystal display device is carried out by changing the orientation of the liquid crystal molecules in a manner of adjusting the voltage applied to both electrodes so that the output of light passing through the liquid crystal is changed.

Specifically, where the applied voltage is lower than a threshold value, the polarizing direction of the linearly polarized light having passed through the polarizing plate on an light incident side rotates (optical rotation) by 90° along the twisting of the liquid crystal molecules so that the light optically rotated passes through the polarizing plate on the light emission side orthogonally arranged to the polarizing plate on the light incidence side and is displayed in a right status (white display). On the other hand, if the applied voltage becomes higher than the threshold value, the long axes of the liquid crystal molecules start to stand from the center portion between the electrodes so that the optical activity starts to decrease. Further if the applied voltage becomes further high, the optical activity will be eventually lost so that the linearly polarized light having passed through the polarizing plate on the light incidence side reaches the polarizing plate on the light emission side without optically rotating. Thus, the light cannot be emitted and is displayed in a dark status (black display).

Meanwhile, such a liquid crystal display device presented a problem that since the external light in the room or from a window reflects from an image display plane, tightness of black in black display deteriorates to decrease the contrast. This is mainly attributable to reflection (surface reflection) at the interface between the display outermost face and the air and reflection (internal reflection) at a color filter region. Until now, the reflectance in the former reflection was generally higher than that in the latter reflection. Therefore as a countermeasure therefor, a low reflectance film having a multiple-layer interference effect was bonded onto the image display plane, thereby decreasing the reflectance.

However, where the low reflectance film is bonded to suppress the surface reflectance at the air interface to a certain degree or lower, the latter internal reflection on the color filter surface, particularly the reflection on the black matrix surface has relatively led to a new problem in improving the contrast.

Conventionally, the black matrix for the color filter was formed by for example, (1) photo-etched relief of a chromium (Cr) film formed by vapor deposition, sputtering, etc. (2) electrocoating of black electrocoating paint, and (3) printing (see JP-A-2002-371204). Until now, the black matrix for the color filter which has sufficiently reduced the reflectance while assuring the dimension accuracy has not been proposed. Therefore the countermeasure therefor has been required.

As described above, conventionally, of the reflections of the external light on the image display plane, the countermeasure for the surface reflection at the air interface has been carried out sufficiently to a certain degree. However the countermeasure for the internal reflection on the color filter has not been carried out sufficiently. Therefore it has become important to solve the problem of the internal reflection in order to further improve the contrast.

### SUMMARY OF THE INVENTION

In view of the above circumstances, an object of this invention is to provide a transmissive color liquid crystal display device which can reduce the reflection on a color filter and further improve the contrast.

(First Aspect)

(1) A transmissive color liquid crystal display device comprising a lower polarizing plate on a light source side, an upper polarizing plate on a display side, a liquid crystal panel arranged between the lower polarizing plate and the upper polarizing plate for changing a polarization plane of linearly polarized light having passed through the lower polarizing plate to adjust light transmittance, and a color filter arranged between the liquid crystal panel and the upper polarizing plate, wherein a phase plate is arranged between the upper polarizing plate and the color filter for rotating a polarization plane of external light passing through the upper polarizing plate and reflecting at the color filter to an angle permitting the upper polarizing plate to absorb the external light.

(2) In the transmissive color liquid crystal display device, the phase plate preferably includes a single ¼ wavelength plate for rotating the polarization plane of the external light by 90° through round-trip passage of the external light having passed through the upper polarizing plate.

(3) In the transmissive color liquid crystal display device, another ¼ wave plate is preferably arranged between the color filter and the liquid crystal panel.

(4) In the transmissive color liquid crystal display device, the liquid crystal panel is preferably a TN type, an IPS type or a VA type.

In accordance with (1) of the first aspect of this invention, a phase plate is arranged between the upper polarizing plate and the color filter for rotating a polarization plane of external light passing through the upper polarizing plate and reflecting at the color filter by a predetermined angle. Thus, the reflecting light on the color filter can be absorbed by the upper polarizing plate. In this case, the external light (linearly polarized light) having passed through the upper polarizing plate passes the phase plate twice forth and back. For this reason, the polarization plane must be located at the angle at which the light cannot pass through the upper polarizing plate when the light passes through the phase plate twice.

For this reason, in the invention of (2), as the phase plate, a single ¼ wave plate (λ/4 plate) is employed. When the linearly polarized light (external light) having passed through the upper polarizing plate passes through the ¼ wave plate twice, its polarization plane rotates by 90°. Thus, this light is the polarized light with the polarization plane orthogonal to the upper polarizing plate so that it cannot pass through the upper polarizing plate and does not return to the side of a viewer. In short, the reflection can be prevented surely.

Meanwhile, if the ¼ wave plate is provided on the color filter, the light having passed through the liquid crystal panel reaches the upper polarizing plate after having passed through the ¼ wave plate so that as the case may be, the display is not done appropriately. For this reason, in the invention of (3), another ¼ wave plate is arranged beneath the color filter. Namely, through the two ¼ wave plates, the polarization plane of the passed light is rotated by 90°. Thus, the light having passed through the liquid crystal panel can pass through the upper polarizing plate so that the display can be done appropriately.

(Second Aspect)

(5) A transmissive color liquid crystal display device comprising a lower polarizing plate on a light source side, an upper polarizing plate on a display side, a liquid crystal panel arranged between the lower polarizing plate and the upper polarizing plate, and a color filter arranged between the liquid crystal panel and the upper polarizing plate, further comprising a member for reducing light intensity of external light passing through the upper polarizing plate and reflecting at the color filter, which is arranged between the upper polarizing plate and the color filter.

(6) In the transmissive color liquid crystal display device, the member for reducing light intensity is preferably an ND filter.

(7) In the transmissive color liquid crystal display device, light absorption rate of the ND filter is preferably 5% or higher.

In accordance with the second aspect of this invention, between the upper polarizing plate and the color filter, a member is arranged for reducing light intensity of external light passing through the upper polarizing plate and reflecting at the color filter. This can reduce the influence of the reflecting light entering the view's eyes, thereby permitting the contrast of a displayed image to be enhanced. For example, where the ND filter (light quantity reducing filter) is employed, the reflecting light on the color filter when the external light is incident passes through the ND filter twice so that the light quantity is reduced by the quantity proportional to twice of the thickness of the ND filter (ND layer). On the other hand, the incident light from the backlight for forming an image passes only once through the ND filter, the light quantity is reduced by only once of the thickness of the ND filter (ND layer). Thus, as compared with reduction in the light quantity employed for image display, the light quantity of the reflecting light of the external light can be reduced twice. This leads to the liquid crystal display with high contrast. Incidentally, if the reduction in the light quantity for image display by the ND filter is compensated for by an increase in the light quantity from the backlight, influence of the reduction in the light quantity for display can be eliminated.

### BRIEF DESCRIPTION OF THE DRAWINGS

FIG. 1 is a schematic sectional view of a transmissive color liquid crystal display device for explaining an embodiment according to the first aspect of this invention.

FIG. 2 is a schematic sectional view of a transmissive color liquid crystal display device for explaining an embodiment according to the second aspect of this invention.

Reference numerals are used to identify various elements in the drawings including the following:
100 transmissive color liquid crystal display device
11 light source
17 liquid crystal panel
18 lower polarizing plate
19 upper polarizing plate
20 color filter
21, 22 λ/4 (¼ wave plate, phase plate)
23 ND filter

### DETAILED DESCRIPTION OF THE INVENTION

Now referring to the drawings, an explanation will be given of an embodiment according to the first aspect of this invention.

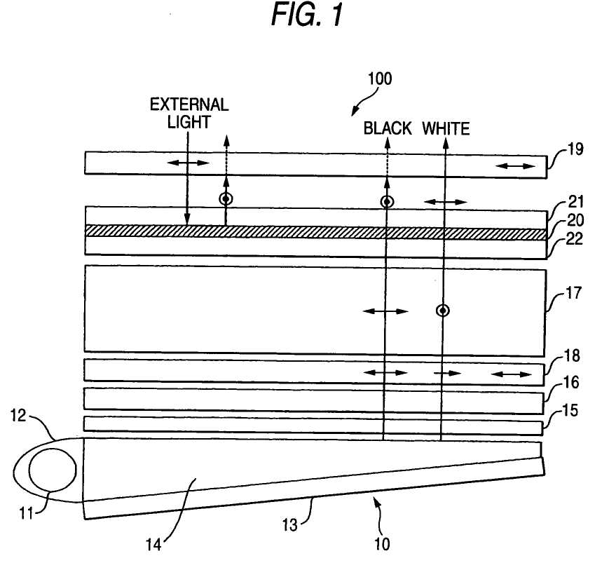

FIG. 1 is a schematic sectional view of a transmissive color liquid crystal display device for explaining an embodiment according to the first aspect of this invention.

In a transmissive color liquid crystal display device 100, between a lower polarizing plate 18 on a light source 11 side and an upper polarizing plate 19 on a display side, a liquid crystal panel 17 is arranged for changing a polarization plane of linearly polarized light having passed through the lower polarizing plate 18 to adjust light transmittance (switching control in the case of ON/OFF). Between the liquid crystal panel 17 and the upper polarizing plate 19, a color filter 20 is arranged which is provided with λ/4 plates (¼ wave plates) 21 and 22 serving as phase plates on the upper and lower surface thereof. The liquid crystal panel 17 includes a liquid crystal layer, glass plates sandwiching it, driving electrodes, etc.

A backlight unit 10 is an edge light type of unit which includes a light source 11, e.g. a cold cathode ray tube for illuminating the liquid crystal panel 17 from behind, a reflecting plate 12 for reflecting the light from the light source 11, a light guiding plate 14 for guiding the light from the light source 11 and the light reflected from the reflecting plate 12 toward the liquid crystal panel 17 and a diffusing plate (or reflecting plate) 13 for returning the light emerging from the light guiding plate 14 into the light guiding plate 14 or toward the liquid crystal panel 17. Between the light guiding plate 14 and the lower polarizing plate 18, arranged are a diffusing film 15 for diffusing the light emitted from the light guiding plate 14 and a light collecting filter 16 for collecting the light diffused by the diffusing film 15 and causing the light thus collected to be incident on the liquid crystal panel 17. Incidentally, the diffusing plate (or reflecting plate) 13, light guiding plate 14, diffusing film 15, light collecting filter 21, lower polarizing plate 18, liquid crystal panel 17, λ/4 plate 22, color filter and λ/4 plate 21 and upper polarizing plate 19 are successively stacked in this order.

The liquid crystal panel 17 used is a twisted-nematic (TN) type, super-twisted-nematic (STN) type, IPS type, or VA type. The color filter 20 is constituted by filters of red (R) green (G) and blue (B) and black matrices arranged in the gaps between these filters.

The lower polarizing plate 18 has a function of passing a specific polarized light component of the light at all orientations from the light collecting filter 16. The upper polarizing plate 19 has also a function of passing a specific polarized light component. Now, in the lower polarizing plate 18 and upper polarizing plate 19, the directions of the polarized light is set equally (indicated in arrows in a right-left direction) but not in an orthogonal relationship.

An explanation will be given of the operation of the display device according to this embodiment.

Where external light is incident through upper polarizing plate 19, because the incident light passes twice through the λ/4 plate 21 in a round-trip, the reflecting light at the color filter 20 is converted into linearly polarized light with the polarization plane perpendicular to that of the linearly polarized light of the incident light. Thus, the reflecting light is absorbed by the upper polarizing plate 19 and does not reach a viewer's eyes. For this reason, the reflection of the external light is suppressed, thereby realizing the liquid crystal display with a high contrast. Incidentally, now, using the λ/4 plate 21, the polarization plane of the external light is rotated by 90°. But the rotation angle is not necessarily required to be 90°, but may be the angle permitting the upper polarizing plate 19 to absorb the reflecting light from the color filter 20 to an invisible degree. Namely, in place of the λ/4 plate, a phase plate capable of rotating the polarization plane by the above angle may be used, thereby giving the same effect.

On the other hand, the light from the backlight unit 10 is polarized by the lower polarizing plate 18 so that only the light in the right-and-left direction in FIG. 1 is incident on the liquid crystal panel 17. The light transmittance of the liquid crystal panel 17 is adjusted by the voltage applied between the transparent electrodes not shown. Specifically, the molecule array of the liquid crystal is changed according to the applied voltage to adjust the light transmittance. In the case of white display, the polarization plane rotates by 90° when the light passes through the liquid crystal panel 17. In the case of black display, the polarization plane is unchanged. The light having passed through the liquid crystal panel 17 passes twice through the λ/4 plate 21, 22 before and after the color filter 20 when it passes through the color filter 20 so that the polarization plane is rotated by 90°. Thus, in the case of white display, the light passes through the upper polarizing plate 19 whereas in the case of black display, the light is absorbed by the upper polarizing plate 19, thereby accurately executing black-and-white (monochromatic) display.

In order to suppress the reflection of the external light, the λ/4 plate 22 is not required indispensably. But in the absence of the λ/4 plate 22, the light having passed through the liquid crystal panel 17 passes only once through the λ/4 plate 21. So after having passed through the λ/4 plate 21, it results in circularly polarized light which cannot pass through the upper polarizing plate 19, thereby making accurate display impossible. In order to obviate such an inconvenience, the liquid crystal display device 100 is provided with the λ/4 plate 22 between the liquid crystal panel 17 and the color filter 20. This realizes the accurate display as described above. Incidentally, in the embodiment described above, in the lower polarizing plate 18 and upper polarizing plate 19, the directions of the polarized light have been equally set but may be in an orthogonal relationship. For example, where the direction of the polarized light in the upper polarizing plate 19 is perpendicular to paper face, black display becomes white display and the white display becomes the black display. But if the data to be displayed is previously inverted, the image can be accurately displayed.

Further, because the liquid crystal display device 100 employs the TN type, STN type, IPS type or VA type of liquid crystal panel 17, even when the λ/4 plates 21, 22 are not provided, the image display can be carried out. The provision of the λ/4 plate 21 intends to improve the contrast and the provision of the λ/4 plate 22 intends to prevent the provision of the λ/4 plate 21 from disabling the image display.

Further, in the embodiment described above, as the phase plate, the λ/4 plates 21, 22 were adopted, but other phase plates may be adopted.

### EXAMPLE

The advantage of the first aspect of this invention will be verified below referring to an example.

A manufactured example was a transmissive color liquid crystal display device (referred to as device A1) in which the λ/4 plates 21,22 are bonded to a glass substrate equipped with the color filter so that the λ/4 plates 21,22 are attached to the upper and lower surfaces of the color filter. A manufactured comparative example was another transmissive color liquid crystal display device (referred to as device B1) in which no λ/4 plate is attached to the upper and lower surfaces of the color filter. In the device A1, in order to remove the reflection on the surface with respect to the measurement of the reflectance, the upper polarizing plate 19 was made apart from the λ/4 plate 21. In this case, the degree of being apart was determined as follows. Namely, where the light source is located at 45° from the normal line to the image display plane, the position was empirically determined which permits the regular reflection on the upper polarizing plate 19 and that on the color filter 20 to be measured separately. The degree of being apart was the degree of giving the position thus determined.

And with a fluorescent lamp (10000 cd/m²) located at the position of an incident angle of 45° from the normal line to the image display plane of the devices A1 and B1, the parallel light reflectance (%) of the regular reflecting light on the color filter 20 was measured for each of the devices A1 and B1. Further, when the power for each of the devices A1, B1 is OFF, a white plate with brightness of 100 cd/m² is reflected or projected onto the image display plane of each of both devices from the position of 45° from the normal line thereby to evaluate the corresponding visual reflection.

As a result of measurement, the parallel light reflectance was 0.42% for device A1, and 2.7% for device B1. Thus, it was confirmed that the reflectance can be suppressed more greatly in the configuration with provided with two λ/4 plates sandwiching the color filter therebetween as in this invention. Further, as a result of evaluation, the good result (reflection is not obtrusive) was obtained for device A1, whereas undesirable result (reflection is obtrusive) was obtained for device B1. Thus, it was confirmed that the reflection can be more greatly suppressed in the configuration provided with two λ/4 plates sandwiching the color filter therebetween as in this invention.

Now referring to the drawings, an explanation will be given of an embodiment according to the second aspect of this invention.

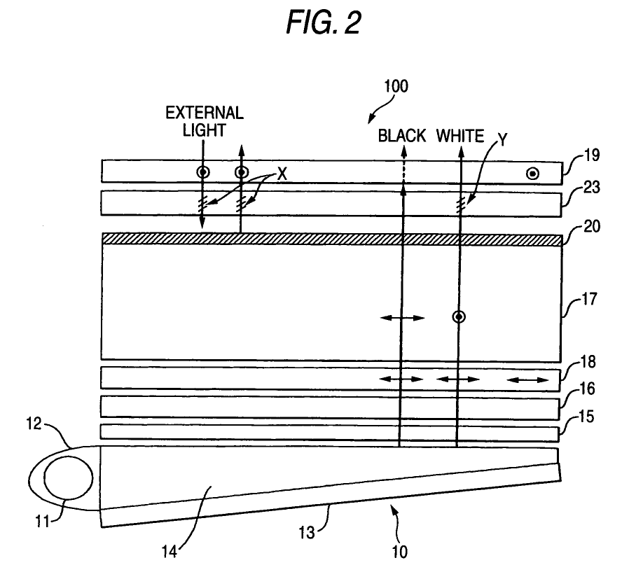

FIG. 2 is a schematic sectional view of a transmissive color liquid crystal display device for explaining an embodiment according to the second aspect of this invention.

In a transmissive color liquid crystal display device 100, between a lower polarizing plate 18 on a light source 11 side and an upper polarizing plate 19 on a display side, a liquid crystal panel 17 is arranged. Between the liquid crystal panel 17 and the upper polarizing plate 19, a color filter 20 is arranged. Beneath the lower polarizing plate 18, a backlight unit 10 is arranged. Further, between the upper polarizing plate 19 and the color filter 20, an ND filter (light quantity reduction filter) 23 is arranged as a member for reducing the light intensity of external light which passes through the upper polarizing plate 19 and reflects at the color filter 20. The absorption rate of the ND filter 23 is preferably 5% or higher and more preferably 10% or higher. The liquid crystal panel 17 includes a liquid crystal layer, glass plates sandwiching it, driving electrodes, etc.

A backlight unit 10 is an edge light type of unit which includes a light source 11, e.g. a cold cathode ray tube for illuminating the liquid crystal panel 17 from behind, a reflecting plate 12 for reflecting the light from the light source 11, a light guiding plate 14 for guiding the light from the light source 11 and the light reflected from the reflecting plate 12 toward the liquid crystal panel 17 and a diffusing plate (or reflecting plate) 13 for returning the light emerging from the light guiding plate 14 into the light guiding plate 14 or toward the liquid crystal panel 17. Between the light guiding plate 14 and the lower polarizing plate 18, arranged are a diffusing film 15 for diffusing the light emitted from the light guiding plate 14 and a light collecting filter 16 for collecting the light diffused by the diffusing film 15 and causing the light thus collected to be incident on the liquid crystal panel 17. Incidentally, the diffusing plate (or reflecting plate) 13, light guiding plate 14, diffusing film 15, light collecting filter 16, lower polarizing plate 18, liquid crystal panel 17, color filter 20, ND filter 23 and upper polarizing plate 19 are successively stacked in this order.

The liquid crystal panel 17 used is a twisted-nematic (TN) type, super-twisted-nematic (STN) type, IPS type, or VA type for changing the polarization plane of the linearly polarized light having passed through the lower polarizing plate 18 to adjust the light transmittance (switching control in the case of ON/OFF). But without being limited to these types, the liquid crystal panel maybe any known liquid crystal panel. The color filter 20 consists of filters of red (R), green (G) and blue (B) and black matrices arranged in the gaps between these filters.

The lower polarizing plate 18 has a function of passing a specific polarized light component of the light at all orientations from the light collecting filter 16. The upper polarizing plate 19 has also a function of passing a specific polarized light component. Now, in the lower polarizing plate 18 and upper polarizing plate 19, the directions of the polarized light is set in an orthogonal relationship.

An explanation will be given of the operation of the display device according to this embodiment. The light from the backlight unit 10 is polarized by the polarizing plate 18 so that the polarized light is incident on the liquid crystal panel 17. The light transmittance of the liquid crystal panel 17 is adjusted by the voltage applied between the transparent electrodes not shown. Specifically, the molecule array of the liquid crystal is changed according to the applied voltage to adjust the light transmittance. In the case of white display, the polarization plane rotates by 90° when the light passes through the liquid crystal panel 17. In the case of black display, the polarization plane is unchanged. The light having passed through the color filter 20 further passes only once through the ND filter 23 so that the light with the reduced light quantity reaches the upper polarizing plate 19. And in the case of white display, the light passes through the upper polarizing plate 19 as it is, whereas in the case of black display, the light is absorbed by the upper polarizing plate 19.

On the other hand, where external light is incident through upper polarizing plate 19, the reflecting light on the color filter 20 passes twice through the ND filter 23 in a round-trip (indicated by X in FIG. 2), its light quantity is reduced by the quantity proportional to twice of the thickness of the ND filter (ND layer). Thus, as compared with the reduction in the light quantity employed for image display (when passes once indicated by Y in FIG. 2), the light quantity of the reflecting light of the external light can be reduced twice. This permits the influence of the reflecting light entering the viewer's eyes to be reduced, thereby enhancing the contrast of the displayed image. Incidentally, if the reduction in the light quantity for image display by the ND filter 23 is compensated for by the increase in the light quantity by the backlight (light source 11), the influence of the reduction in the light quantity for image display can be eliminated.

### EXAMPLE

The advantage of the second aspect of this invention will be verified below referring to an example.

A transmissive color liquid crystal display device (referred to as device A2) which is manufactured to have the configuration shown in FIG. 2 was prepared as an example. A transmissive color liquid crystal device (referred to as device B2) which is manufactured to have the configuration shown in FIG. 2 but not equipped with the ND filter 23 was prepared as a comparative example. In device A2, in order to remove the reflection on the surface with respect to the measurement of the reflectance, the upper polarizing plate 19 was made apart from the ND filter 23. In this case, the degree of being apart was determined as follows. Namely, where the light source is located at 45° from the normal line to the image display plane, the position was empirically determined which permits the regular reflection on the upper polarizing plate 19 and that on the color filter 20 to be measured separately. The degree of being apart was the degree of giving the position thus determined.

And in devices A2 and B2, with a white plate having brightness of 100 cd/m² (illuminated by a fluorescent lamp) located at the position of 45° from the normal line to the image display plane, the reflectance of the regular reflecting light on the color filter 20 was measured at the reflecting portion of the white plate in both white display and black display. The contrast was defined by the ratio in both display cases. Now, as the ND filter for device A2, two kinds of ND filters having the absorption rates of 5% and 10% were adopted. Further, in order to eliminate the stray light in the room, experiments were carried out in a dark room.

The measurement results are as follows. In device A2 with the ND filter having the absorption rate of 5%, the contrast was 259, and in device A2 with the ND filter having the absorption rate of 10%, the contrast was 270. In device B2, the contrast was 250. Thus it was known that the configuration provided with the ND filter can improve the contrast more greatly. Further, it was known that if the absorption rate of the ND filter is 5% or more, the contrast can be improved, and if the absorption rate of the ND filter is 10% or more, the contrast can be further improved.

What is claimed is:

1. A transmissive color liquid crystal display device comprising:
a lower polarizing plate on a light source side;
an upper polarizing plate on a display side;
a liquid crystal panel between the lower polarizing plate and the upper polarizing plate for changing a polarization plane of linearly polarized light having passed through the lower polarizing plate to adjust light transmittance;
a color filter between the liquid crystal panel and the upper polarizing plate; and
a phase plate between the upper polarizing plate and the color filter for rotating a polarization plane of external light passing through the upper polarizing plate and reflecting at the color filter to an angle permitting the upper polarizing plate to absorb the external light.

2. The transmissive color liquid crystal display device according to claim 1, wherein the phase plate comprises a single ¼ wave plate for rotating the polarization plane of the external light by 90° in a round-trip passage of the external light having passed through the upper polarizing plate.

3. The transmissive color liquid crystal display device according to claim 2, wherein another ¼ wave plate is arranged between the color filter and the liquid crystal panel.

4. The transmissive color liquid crystal display device according to claim 1, wherein the liquid crystal panel is one of a TN type, an IPS type and a VA type.

5. The transmissive color liquid crystal display device according to claim 1, which comprises a backlight unit having a light source, a reflecting plate, a light guiding plate, and a diffusing plate.

6. The transmissive color liquid crystal display device according to claim 5, which comprises a diffusing film and a light collecting filter between the light guiding plate and the lower polarizing plate.

7. A transmissive color liquid crystal display device comprising:
a lower polarizing plate on a light source side;
an upper polarizing plate on a display side;
a liquid crystal panel between the lower polarizing plate and the upper polarizing plate;
a color filter between the liquid crystal panel and the upper polarizing plate; and
a member for reducing light intensity of external light passing through the upper polarizing plate and reflecting at the color filter, which is arranged between the upper polarizing plate and the color filter.

8. The transmissive color liquid crystal display device according to claim 7, wherein the member for reducing light intensity is an ND filter.

9. A transmissive color liquid crystal display device according to claim 7, wherein light absorption rate of the ND filter is 5% or higher.

10. The transmissive color liquid crystal display device according to claim 7, wherein the liquid crystal panel is one of a TN type, an IPS type and a VA type.

11. The transmissive color liquid crystal display device according to claim 7, which comprises a backlight unit having a light source, a reflecting plate, a light guiding plate, and a diffusing plate.

12. The transmissive color liquid crystal display device according to claim 11, which comprises a diffusing film and a light collecting filter between the light guiding plate and the lower polarizing plate.
